(19) United States
(12) Patent Application Publication
(10) Pub. No.: US 2020/0385626 A1
(43) Pub. Date: Dec. 10, 2020

(54) INVERT-EMULSION OIL BASED MUD FORMULATION USING CALCIUM SALT OF FATTY ACID AS PRIMARY EMULSIFIER

(71) Applicant: SAUDI ARABIAN OIL COMPANY, Dhahran (SA)

(72) Inventors: Jothibasu Ramasamy, Dhahran (SA); Md Amanullah, Dhahran (SA); Mujtaba M. Alsaihati, Dammam (SA)

(73) Assignee: SAUDI ARABIAN OIL COMPANY, Dhahran (SA)

(21) Appl. No.: 17/000,825

(22) Filed: Aug. 24, 2020

Related U.S. Application Data
(63) Continuation-in-part of application No. 16/750,389, filed on Jan. 23, 2020.
Application No. 16/750,389 is a division of application No. 15/812,694, filed on Nov. 14, 2017, now Pat. No. 10,577,527.

(51) Int. Cl. C09K 8/34; C11C 3/00; B01F 17/00; C09K 8/36

(52) U.S. Cl. CPC C09K 8/34; C09K 8/36; B01F 17/0021; C11C 3/00

(57) ABSTRACT

A method of making an invert oil-based mud (OBM), a composition for an invert OBM, and a method of using an invert OBM are provided. The invert OBM includes an oil-based fluid, an emulsifier comprising a calcium salt of an alkyl esterified fatty acids from a vegetable oil, an emulsion activating agent, and a water-based fluid.

### CROSS-REFERENCE TO RELATED APPLICATIONS

This application is a continuation-in-part of and claims the benefit of U.S. patent application Ser. No. 16/750,389, filed Jan. 23, 2020, which is a division of and claims the benefit of U.S. patent application Ser. No. 15/812,694, filed Nov. 14, 2017, now U.S. Pat. No. 10, 577,527, each of which are incorporated by reference in their entirety.

### TECHNICAL FIELD

This disclosure relates to drilling fluids, for example, wellbore drilling fluids to drill wellbores in hydrocarbon formations.

### BACKGROUND

Wellbore drilling operations use wellbore drilling fluids for multiple purposes including, for example, to cool the drill bit, to transport wellbore cuttings from inside the wellbore to the surface, or similar purposes. Drilling fluids are also used to reduce friction between the drill string and the casing or the wellbore wall by acting as a lubricating medium for the drill string while drilling the wellbore. Drilling fluids can be divided into categories, for example, oil-based drilling fluids, water-based drilling fluids, or similar categories. Sometimes, additives are added into either or both categories of drilling fluids to enhance the properties of the drilling fluids.

### SUMMARY

This specification describes technologies relating to a waste vegetable oil-based emulsifier for invert-emulsion oil-based mud formulation.

Certain aspects of the subject matter described here can be implemented as a method. A first emulsifier is prepared from an alkyl ester of waste vegetable oil. The waste vegetable oil is vegetable oil which has been used for a process prior to preparing the first emulsifier. A quantity of the first emulsifier is added to an oil-based drilling fluid. A quantity of an activating agent is added to the oil-based drilling fluid. The activating agent is configured to activate the emulsifier to stabilize an emulsion. A quantity of viscosifier is added to the oil-based drilling fluid. A quantity of a second emulsifier is added to the oil-based drilling fluid. A quantity of weigh-up material is added to the oil-based drilling fluid. The resulting oil-based drilling fluid is used in a wellbore drilling operation to drill a wellbore in a subterranean zone.

This, and other aspects, can include one or more of the following features. A ratio of the quantity of the first emulsifier to a quantity of the oil-based drilling fluid can be between 4 pounds of the first emulsifier per barrel of the oil-based drilling fluid and 12 pounds of the first emulsifier per barrel of the oil-based drilling fluid. A ratio of the quantity of the activating agent to a quantity of the oil-based drilling fluid can be substantially 4 grams of the activating agent per barrel of the oil-based drilling fluid. A ratio of the quantity of the viscosifier to a quantity of the oil-based drilling fluid can be substantially 4 grams of the viscosifier per barrel of the oil-based drilling fluid. A ratio of the quantity of the second emulsifier to a quantity of the oil-based drilling fluid can be substantially 6 grams of the second emulsifier per barrel of the oil-based drilling fluid. A ratio of the quantity of brine to a quantity of the oil-based drilling fluid can be substantially 85 milliliters of brine per barrel of the oil-based drilling fluid. The brine can include a quantity of calcium chloride dissolved in water. The brine can include substantially 61 grams of calcium chloride per 85 cubic centimeter of water. A ratio of the quantity of weigh-up material to a quantity of the oil-based drilling fluid can be substantially 161 grams of weigh-up material per barrel of the oil-based drilling fluid. Using the oil-based drilling fluid in the wellbore drilling operation to drill a wellbore in a subterranean zone can include flowing the oil-based drilling fluid through the wellbore while drilling the subterranean zone.

Certain aspects of the subject matter described here can be implemented as a method. A raw material waste vegetable oil is esterified to produce a methyl ester of the raw material waste vegetable oil. A caustic soda solution is added to the methyl ester resulting in a mixture. The mixture is thermally treated. A pH of the mixture is adjusted resulting in formation of an aqueous phase and a non-aqueous phase. The aqueous phase is separated from the non-aqueous phase.

This, and other aspects, can include one or more of the following features. The caustic soda solution can include an alkoxide dissolved in a solvent. The alkoxide can include sodium hydroxide. The solvent can include water. The mixture can be stirred during thermally treating the mixture. The mixture can be heated to a temperature greater than room temperature. The temperature can be substantially 60° C. Acid can be added to adjust the pH of the mixture. The acid can be substantially 31% hydrochloric acid. The adjusted pH of the mixture can be substantially between 4 and 5.

The details of one or more embodiments of the subject matter described in this specification are set forth in the accompanying drawings and the description that follows. Other features, aspects, and advantages of the subject matter will become apparent from the description, the drawings, and the claims.

In an aspect, a method of making an invert oil-based mud (OBM) includes introducing an emulsifier comprising a calcium salt of an alkyl esterified fatty acids from a vegetable oil to an oil-based fluid to form an oil-based fluid mixture. Embodiment methods also include introducing an emulsion activating agent to the oil-based fluid mixture. Embodiment methods also include introducing a water-based fluid to the oil-based fluid mixture such that the invert OBM forms.

In some embodiments, the quantity of the calcium salt introduced is in a range of from about 4 pounds per barrel (ppb) to about 12 ppb. In some embodiments, the alkoxy group of the calcium salt is selected from the group consisting of methoxy, ethoxy, propoxy, butoxy, and combinations thereof. In some embodiments, the oil-based fluid is selected from the group consisting of refined mineral oil, diesel oil, and combinations thereof. In some embodiments, the ratio of emulsion to emulsion activating agent is in a range of from about 1:1 to about 1:2. In some embodiments, the emulsion activating agent is lime. In some embodiments, the emulsion activating agent is introduced after introducing the calcium salt. In some embodiments, the water-based fluid is a synthetic brine comprising calcium chloride. In some embodiments, the invert OBM has a water-to-oil volume ratio in a range of from about 50:50 to about 10:90. In some embodiments, the weighting material is introduced after the water-based fluid is introduced. In some embodiment, the invert oil-based mud has a density in a range of from about 60 pounds per cubic foot (pcf) to about 160 pcf. In some embodiments, a wetting agent is introduced after the emulsion activing agent is introduced. In some embodiments, the vegetable oil comprises a waste vegetable oil. In some embodiments, the emulsifier further comprises sodium salts of esterified fatty acids from a waste vegetable oil. In some other embodiments, the emulsifier consists essentially of the calcium salts of saturated fatty acids. In yet some other embodiments, the emulsifier consists essentially of the calcium salts of unsaturated fatty acids.

In another aspect, a composition comprising an invert oil-based mud (OBM) includes an oil-based fluid, an emulsifier comprising a calcium salt of an alkyl esterified fatty acids from a vegetable oil, an emulsion activating agent, and a water-based fluid. The composition has a water-to-oil volume ratio in a range of from about 50:50 to about 10:90.

In another aspect, a method of using an invert oil-based mud (OBM) includes introducing the invert OBM into a wellbore. The invert OBM comprises an oil-based fluid, an emulsifier comprising a calcium salt of an alkyl esterified fatty acids from a vegetable oil, an emulsion activating agent, and a water-based fluid. The composition has a water-to-oil volume ratio in a range of from about 50:50 to about 10:90.

In some embodiments, the wellbore has a section that is high-temperature/high-pressure (HTHP). In some embodiments, the wellbore has a section that contains reactive shales.

### BRIEF DESCRIPTION OF THE DRAWINGS

FIG. 1 is a schematic diagram of a drilling fluid circulation system.

FIG. 2 is a schematic diagram showing drilling fluid flowing through a drill string and an annulus between the drill string and a wellbore.

FIGS. 3A and 3B are flowcharts of example processes of producing emulsifier using esterified waste and non-waste vegetable oils.

FIG. 4 is a flowchart of an example process of producing esterified waste vegetable oil.

FIGS. 5A and 5B are flowcharts of example processes for using the emulsifier produced by the example processes described by and shown in FIGS. 3A and 3B to form an oil-based drilling fluid.

FIG. 6 is a representation of the resultant product between an alkyl ester of a vegetable oil and slaked lime.

Like reference numbers and designations in the various drawings indicate like elements. In the figures, down are toward or at the bottom and up are toward or at the top of the figure. “Up” and “down” are generally oriented relative to a local vertical direction. However, “upstream” in the oil and gas industry may more generally refer to objects, units or processes taken before a particular unit or process. As well, “downstream” may more generally refer to objects, units or processes taken after a particular unit or process. As used throughout this disclosure, the terms “uphole” and “downhole” may refer to a position within a wellbore relative to the surface, with “uphole” indicating direction or position closer to the surface entry point and “downhole” referring to direction or position farther away from the surface entry point. One of ordinary skill in the art understands that an object or a process may be “uphole” or “downhole” of another object or process while having the same true vertical depth relative to the surface of the earth.

### DETAILED DESCRIPTION

Water-based drilling fluids may not be a viable drilling fluid option for certain high pressure and high temperature (HPHT) sections of a borehole due to the extreme drilling conditions. For such HPHT sections, invert emulsion oil-based mud (OBM) can be used as drilling fluids. OBMs can also be used as drilling fluids when drilling reactive shale section to stabilize the shale. Certain oil-based drilling fluids, such as the invert emulsion OBM include emulsifiers to create a stable emulsion of water in oil. Emulsifiers are a type of surfactants that have a hydrophilic head group and a hydrophobic tail (for example, a long chain hydrophobic tail). Emulsifiers can reduce interfacial tension between water and oil phases to achieve stability of the drilling fluid.

This disclosure describes an ecofriendly emulsifier that can be used in oil-based drilling fluids, such as invert emulsion OBMs or similar oil-based drilling fluids. In some implementations, the emulsifier is used as a primary emulsifier in an invert emulsion oil-based mud formulation used as a drilling fluid in HPHT sections of a borehole or when drilling highly reactive shale section to stabilize the shale. In general, the emulsifier can be used in OBM that is used in rock formations where high friction and torque are expected or in high extended reach wells (or both). Example ratios of oil to water and concentrations of the emulsifier in the formulation are described later. The emulsifier described here is a primary additive used in invert emulsion OBMs to create stable emulsion of water in oil. The emulsifier can reduce interfacial tension between water and oil phases to increase stability of the drilling fluid.

The emulsifier is a type of surfactant that has both hydrophilic head group and long chain hydrophobic tail. In this disclosure, an ecofriendly emulsifier is prepared using vegetable oil. In some embodiments, used or processed vegetable oil can be obtained, for example, from the food industry. Vegetable oil is a triglyceride extracted from a plant. A triglyceride is an ester of glycerol and three fatty acids. Depending on the source, vegetable oil contains a mixture of different types of fatty acids, for example, saturated, mono unsaturated, poly unsaturated, omega 3, omega 6 or omega 9 fatty acid. Most of the vegetable oils commonly used for cooking (for example, olive oil, palm oil, sunflower oil, corn oil, peanut oil, or similar vegetable oil commonly used for cooking food) contains one or more or all of these fatty acids. The presence of these different types of fatty acids makes vegetable oil a promising source for emulsifiers for drilling fluids. Vegetable oils that have been used for cooking and been disposed as waste could be used as a sustainable source for emulsifier synthesis. Unused or unprocessed vegetable oil, such as virgin, fresh, unused, or raw oils, can also be used for the emulsifier synthesis described here.

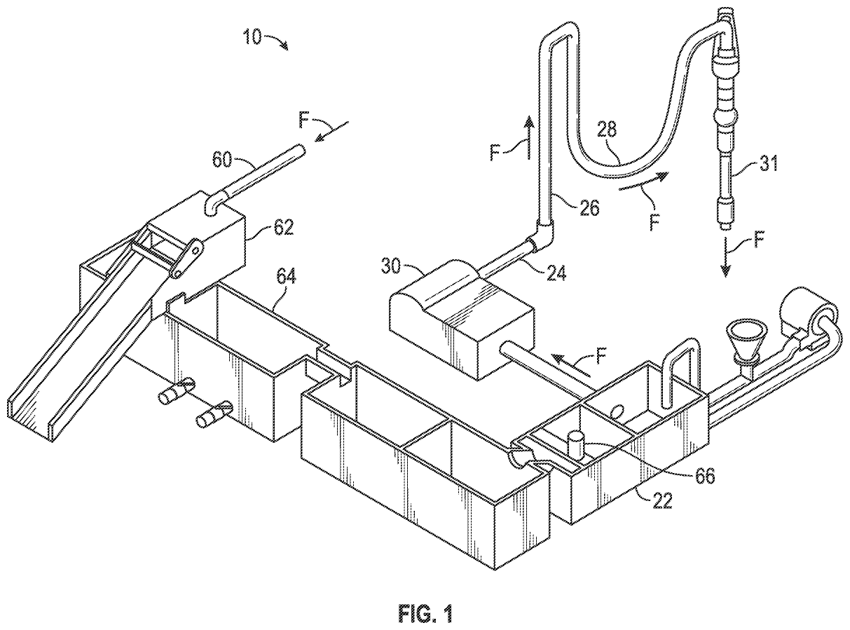

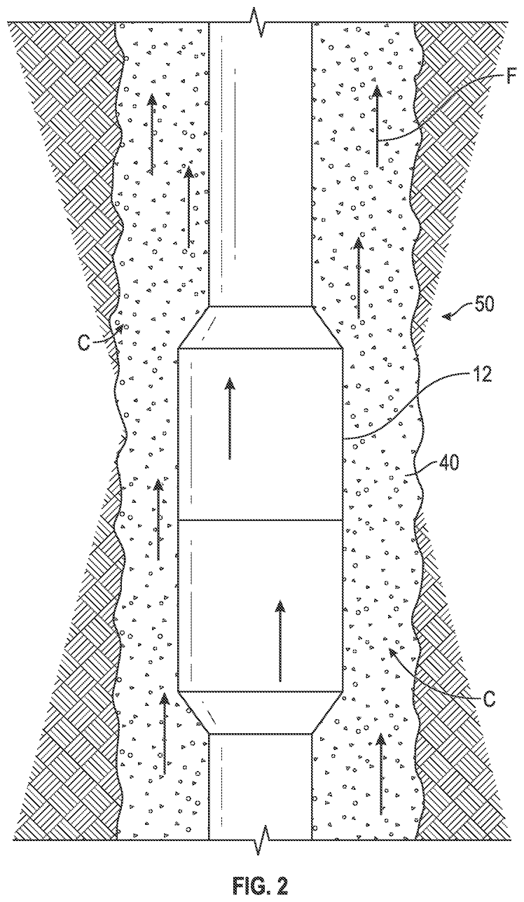

FIG. 1 is a schematic diagram of a drilling fluid circulation system 10. FIG. 2 is a schematic diagram showing drilling fluid flowing through a drill string 12 and an annulus 40 between the drill string 12 and a wellbore 50. In wellbore drilling situations that use a drilling rig, a drilling fluid circulation system 10 circulates (or pumps) drilling fluid (for example, drilling mud) with one or more mud pumps. The drilling fluid circulation system 10 moves drilling fluid (mud, F) down into the wellbore 50 through a drill string 12, and drill collars which are connected to the drill string 12. The drilling fluid exits through ports (jets) in the drill bit, picking up cuttings C and carrying the cuttings of the annulus 40 of the wellbore 50. The mud pump 30 takes suction from mud tank 22 and pumps the drilling fluid F out discharge piping 24, up with the standpipe 26, through rotary hoses 28, through Kelly or top drive unit 31, and into a central bore of the drill string 12, drill collars and drill bit. Drilling fluid F and cuttings C returned to the surface of the annulus 40. At the surface, the drilling fluid and cuttings leave the wellbore 50 through an outlet (not shown) and are sent to a cuttings removal system via mud return line 60. At the end of the return lines, drilling fluid F and cuttings C are flowed onto a vibrating screen, for example, a shale shaker 62. Finer solids can be removed using a sand trap 64. The drilling fluid can be treated with chemicals stored in a chemical tank 66 and then provided into the mud tank 22, wherein the process can be repeated.

The drilling fluid circulation system 10 delivers large volumes of drilling fluid under pressure for the drilling rig operations. The circulation system 10 delivers the drilling fluid to the drill stem to flow down the drill string 12 and out through the drill bit appended to the lower end of the drill stem. In addition to cooling the drill bit, the drilling fluid hydraulically washes away debris, rock chips, and cuttings, which are generated as the drill bit advances into the wellbore 50. Thus, the drilling fluid is an important part of the component drilling operation which can be flowed through wellbore drilling system components, for example, as rotary, coiled tubing, casing, or similar components, in different wellbore drilling operations, for example, under balance drilling, overbalanced drilling, or similar drilling operations, to perform several functional tasks and facilitate safe, trouble-free and economical drilling.

### Processes For Producing The Emulsifier From Vegetable Oils

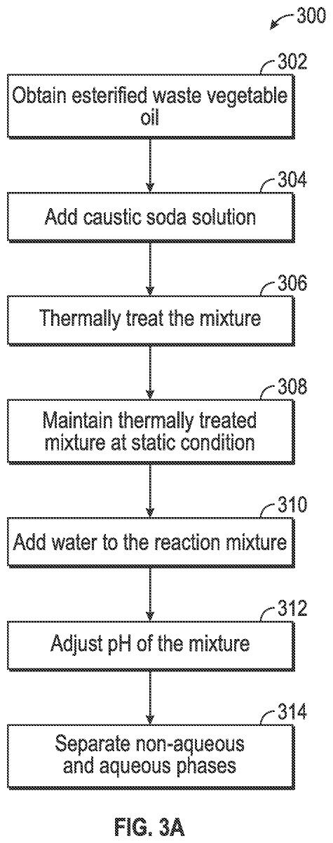

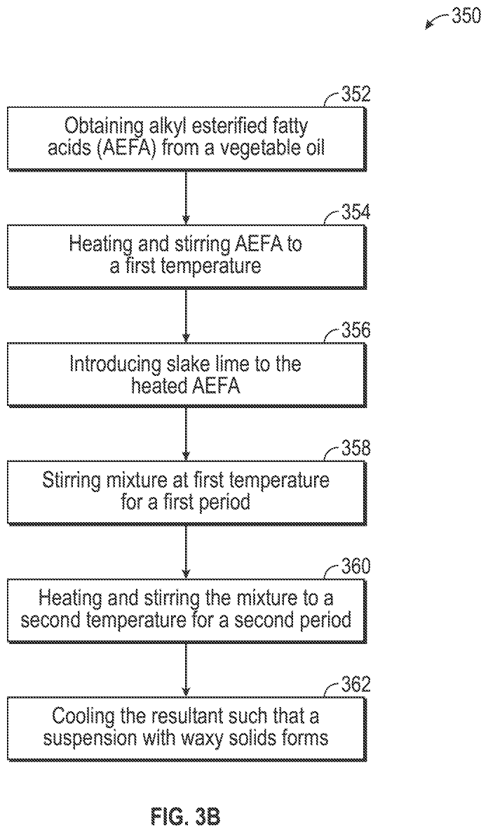

FIG. 3A is a flowchart of an example process 300 of producing emulsifier using esterified waste vegetable oil. In some implementations, the emulsifier can be used in other wellbore fluids, for example, fracturing fluids, completion fluids, stimulation fluids, combinations of them, or similar wellbore fluids. At 302, esterified waste vegetable oil is obtained. In some implementations, a methyl ester of waste vegetable oil is obtained. For example, waste vegetable oil (that is, vegetable oil that has been used for cooking) is esterified to prepare a methyl ester.

At 304, a caustic soda solution is added to the methyl ester of the waste vegetable oil. In some implementations, the caustic soda solution can be prepared by dissolving a quantity of sodium hydroxide in water. In some implementations, the caustic soda solution can be added to the methyl ester of the waste vegetable oil over a period of time that is sufficient for the caustic soda solution and the methyl ester to be mixed. The caustic soda solution can be added at an optimal rate at which the formation of suspension is delayed, as hastened formation of suspension will hinder the caustic soda reaction with methyl ester. Adding the caustic soda solution changes the reaction mixture into a suspension.

At 306, the mixture is thermally treated. In some implementations, the mixture can be stirred (or otherwise agitated) for a certain duration at a temperature that is greater than room temperature. Stirring facilitates and increases contact between the caustic soda and methyl ester. Heating at the temperature creates Brownian motion of the reaction mixture and accelerates reaction kinetics.

At 308, the thermally treated mixture is maintained at a static condition. In some implementations, the agitation of the thermally treated mixture and the heating can be ceased allowing the mixture to cool to room temperature. No other thermal treatment need then be performed on the mixture. Maintaining the mixture at the static condition can allow the methyl groups to be cleaved off, resulting in sodium salts of esterified fatty acids, which is the emulsifier.

At 310, water is added to the reaction mixture to separate the oil and water phases, thereby isolating the emulsifier. The water volume can be 15-30% of the oil volume taken initially for the reaction.

At 312, the pH of the mixture is adjusted. In some implementations, the pH is adjusted by adding an acid to the reaction mixture until the pH of the mixture reaches a level at which an oil phase separates out from the reaction mixture.

At 314, the non-aqueous and aqueous phases are separated. In some implementations, the two phases are separated by first transferring the reaction mixture to a separation flask, from which the aqueous phase is removed. In some implementations, additional water can be added to the separation flask to wash and remove any remaining inorganic salts in the non-aqueous phase. The remaining non-aqueous phase along with emulsion is left in static condition to allow the emulsion to de-foam. The de-foaming may further release water, which can be removed as described earlier. The non-aqueous phase from which the foam has been removed comprising the sodium salts of the esterified fatty acids from the waste vegetable oil is available as the emulsifier for use as described in this disclosure.

FIG. 3B is a flowchart of an example process 350 of producing an emulsifier using an alkyl esterified fatty acids from vegetable oil. In an embodiment, the resultant calcium salts of the alkyl esterified fatty acids from the vegetable oil form a composition that is useful as an emulsifier.

At 352, in some embodiments, alkyl esterified fatty acids of vegetable oil, such as alkyl esterified fatty acids of waste vegetable oil, alkyl esterified fatty acids of virgin vegetable oil, or a blend thereof, is obtained for use. In some embodiments, the alkyl esterified vegetable oil is a waste vegetable oil (that is, vegetable oil that has been used for cooking) that has been esterified. In some other embodiments, the alkyl esterified vegetable oil is a virgin or fresh vegetable oil that has been esterified. In some other embodiments, the alkyl esterified vegetable oil is a blend of waste and virgin vegetable oil that has been esterified.

The term “alkoxy” as used refers to an oxygen atom connected to an alkyl group, including a cycloalkyl group. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning in this disclosure. A methoxyethoxy group is also an alkoxy group within the meaning in this disclosure, as is a methylenedioxy group in a context where two adjacent atoms of a structure are substituted. In some embodiments, the alkoxy group of the alkyl esterified fatty acids of vegetable oil is a methoxy group.

At 354, in some embodiments, the alkyl esterified fatty acids of vegetable oil is heated to a first temperature that is greater than ambient conditions. In some embodiments, the first temperature is about 60° C. In some embodiments, during the heating to the first temperature, the alkyl esterified vegetable oil is agitated. In some such instances, the alkyl esterified vegetable oil is stirred with a stir rod at a rate of about 300 revolutions per minute (RPM).

At 356, in some embodiments, slaked lime is added to the heated alkyl esterified fatty acids of the vegetable oil forming a mixture. In some embodiments, the calcium hydroxide (Ca(OH)₂) is introduced as a solid. In other implementations, the slaked lime can be prepared by dissolving a quantity of calcium hydroxide in water. In some implementations, the calcium hydroxide can be added to the alkyl esters of the fatty acids over a period of time that is sufficient for the slaked lime and the alkyl ester to be mixed. During the introduction, the heated alkyl esterified fatty acids of the vegetable oil are continually stirred. The slaked lime can be added at a rate at which the formation of a suspension is initially avoided. Formation of a suspension may hinder the slaked lime reaction with the alkyl esters of the fatty acids; however, formation of a suspension of solid slaked lime through a controlled pace of addition does permit a slow, tempered and controlled reaction to forming the calcium salts of the fatty acids.

At 358, in some embodiments, the mixture is maintained at a constant stirring rate at the first temperature for a first period. In some embodiments, the first period is about 6 hours (h). In some implementations, the constant stirring rate is about 300 RPM. Stirring facilitates and increases contact between the slaked lime and the alkyl ester of the fatty acids. Maintaining the mixture at the first temperature allows the alkyl groups attached to the esterified fatty acids to be cleaved off and the calcium complexes of the esterified fatty acid to form, resulting in the emulsifier.

At 360, in some embodiments, the temperature of the mixture is modified to a second temperature and held for a second period. In some embodiments, the second temperature is greater than the first temperature. In some embodiments, the second temperature is about 75° C. In some embodiments, the second period is about 1 hour (h). In some implementations, the constant stirring rate is maintained during the second period. The elevation to the second temperature assists in driving off byproduct alcohol, which in this case is methanol, from the product emulsifier, thereby purifying the product emulsifier.

At 362, in some embodiments, the resultant is a suspension with waxy solids and a brown non-aqueous liquid. Although not wanting to be bound by theory, it is believed that the more liquid part contains the calcium salt of unsaturated fatty acids and the more solid, or waxy, or semi-solid phase contains the calcium salts of saturated fatty acids. The suspension is permitted to come to room temperature.

See FIG. 6 for a representation of the embodiment calcium salts of the esterified fatty acids of the vegetable oil. In some embodiments, R₁ is a saturated alkyl chain. In some embodiments, R₂ is a monounsaturated alkyl chain. In some embodiments, R₃ is a polyunsaturated alkyl chain.

In some embodiments, the calcium salts of the unsaturated fatty acids and the calcium salts of the saturated fatty acids are both used as the emulsifier.

In some other embodiments, the calcium salts of unsaturated fatty acids are further separated from the calcium salts of saturated fatty acids. In some such embodiments, the emulsifier consists essentially of the calcium salts of unsaturated fatty acids.

In yet some other embodiments, the calcium salts of saturated fatty acids are further separated from the calcium salts of unsaturated fatty acids. In some such embodiments, the emulsifier consists essentially of the calcium salts of saturated fatty acids.

### Process for Producing Esterified Waste Vegetable Oil

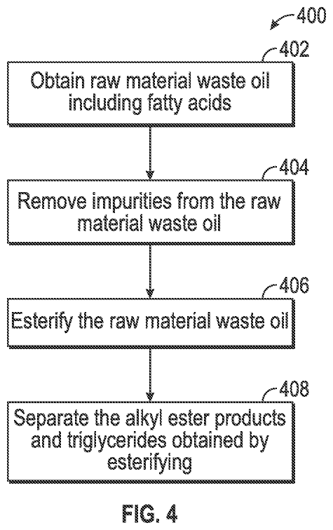

FIG. 4 is a flowchart of an example process 400 of producing esterified waste vegetable oil. For example, the esterified waste vegetable oil produced by implementing process 400 can be used to produce the emulsifier by implementing the process 300. In some implementations, the additive can be used in wellbore fluids, for example, drilling fluids (specifically, oil-based drilling fluids), fracturing fluids, completion fluids, stimulation fluids, combinations of them, or similar wellbore fluids.

At 402, the waste vegetable oil including fatty acids is obtained. In some implementations, the waste vegetable oil can be processed vegetable oil produced as a byproduct by the food industry.

The waste vegetable oil can have a plastic viscosity of greater than substantially 50 centipoise (cP) or 60.8 cP measured using a multi-speed rotational viscometer. The waste vegetable oil can have a plastic viscosity ratio of waste vegetable oil to mineral oil that is greater than substantially 10 (for example, substantially 11.18). As used in this disclosure, the term “substantially” permits a variation of up to 5% from any mentioned value. The waste vegetable oil can have a plastic viscosity ratio of more than substantially 20 with respect to the plastic viscosity of a refined mineral oil and used for offshore drilling. The waste vegetable oil can have a plastic viscosity ratio of substantially 24.12 with respect to the refined mineral oil and used for offshore drilling. The waste vegetable oil can have a plastic viscosity ratio of more than substantially 10 with respect to the plastic viscosity of mineral oils that are used for oil-based drilling fluid formulations.

The waste vegetable oil can include fatty acids with a short chain alcohol. The short chain alcohol can include at least one or more of methanol, ethanol, propanol, butanol, or combinations of them. The fatty acids can include molecules averaging substantially from 16 carbon atoms to less than 20 carbon atoms.

At 404, impurities are removed from the waste vegetable oil. The impurities, for example, food residues, can reduce the functional capability of the waste vegetable oil. In some implementations, the waste vegetable oil can be filtered, for example, quick filtered, at low pressure, for example, a pressure range of substantially 5 pounds per square inch (psi) to substantially 10 psi. Impurities can be removed from the waste vegetable oil using alternative or additional methods.

At 406, the raw material waste oil is esterified. In some implementations, the raw material waste oil is esterified in the presence of a catalyst to produce alkyl ester products and triglycerides. The catalyst can include at least one of sodium hydroxide, potassium hydroxide, sodium alkoxide, potassium alkoxide, or combinations of them. For example, the waste vegetable oil can be esterified with methanol in the presence of sodium hydroxide. At 408, the alkyl ester products and triglycerides are separated. Example techniques for implementing portions of process 400 to produce the esterified waste vegetable oil are described later. Alternative techniques can be implemented to produce the esterified waste vegetable oil.

### Removal of Impurities and Excess Water

A low-pressure filtration cell can be used to remove impurities, for example, burnt and unburned food residue, present in the waste vegetable oil. The low-pressure filtration cell can include filter paper that has pore sizes less than 5 micrometers (μm) to remove impurities larger than 5 μm. A constant pressure of 5-10 psi can be used on the low-pressure cell for quick filtration of a volume of the waste vegetable oil. Other filtration media or adsorbents that are capable of removing all impurities and excess water from the waste vegetable oil can be used as alternatives or in addition to the low-pressure filtration cell. For example, a multi-cell filtration apparatus can be used for removing the impurities.

### Determination of Quantity of Catalyst

A quantity of catalyst required to process the waste vegetable oil can be determined by titration method. To do so, for example, 1 milliliter (mL) of waste vegetable oil can be mixed with 10 mL of isopropyl alcohol of 99.2% purity. To this mixture, 2-3 drops of an indicator fluid (for example, phenolphthalein, or similar indicator fluid) can be added. The indicator fluid can be added drop-by-drop into the agitated waste vegetable oil until the color changes to pink. After the endpoint, the mixture can be stirred for a while to check the permanency of the pink color. The titration test can be repeated three times to calculate the average amount of catalyst required to reach the endpoint. After determining the average value of sodium hydroxide (NaOH) based on the titration test results, a constant value (for example, 3.5 grams (g)) can be added to determine the total amount of catalyst (for example, between 4.18 g and 4.22 g) required for 1 liter (L) of waste vegetable oil.

### Esterification to Remove Triglycerides

The viscosity of the waste vegetable oil can be reduced to match the mineral oil viscosity by esterifying the base oil using methanol. To do so, a volume of methanol, for example, 20% original waste vegetable oil volume, and the mass of NaOH (for example, 4.22 g NaOH/liter of waste vegetable oil) can be mixed in a dry condition using a magnetic stirrer and then added to the waste vegetable oil in a container. The mixture can then be stirred for six hours using the magnetic stirrer to complete the interactions.

### Sedimentation

The total reaction product can be allowed to stay in static conditions overnight to complete the sedimentation of glycerol and sludge at the bottom of the container. During the initial settling phase, emulsion formed, for example, due to the presence of some emulsion forming byproducts in the ester layer, can be broken by heating the processed mass at substantially 80° C. or adding substantially 10 mL of acetic acid per liter of waste vegetable oil to break and prevent the emulsion formation.

### Separation and Washing of Esterified Oil

After complete sedimentation, the top clear esterified oil was decanted slowly and washed for several hours using water while stirring with a magnetic stirrer. Then, the esterified oil and the washed water were kept in static condition overnight for effective separation of oil and water phases. The separated oil phase was decanted slowly to remove it from the water phase. The process of washing was repeated, for example, twice.

### Processes for Using the Emulsifier in an OBM

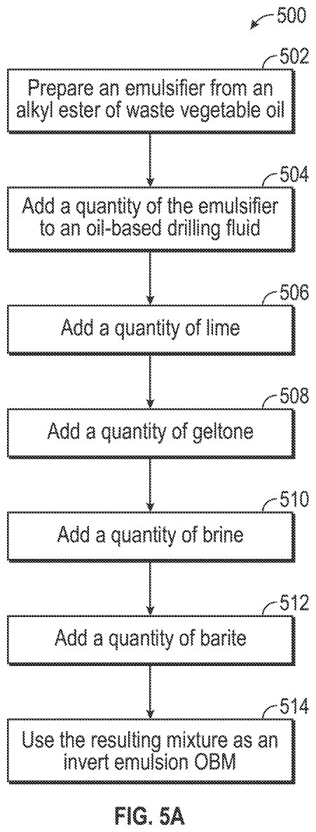

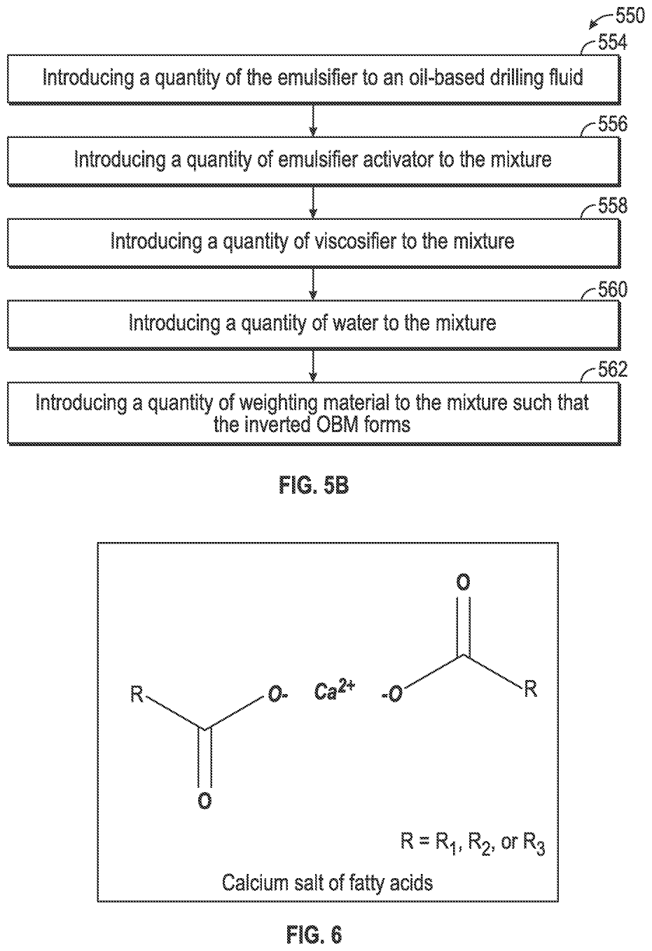

FIG. 5A is a flowchart of an example process 500 for using the emulsifier produced by the example process of FIG. 3A in an oil-based drilling fluid. The process 500 can be implemented, in part, for example, at a surface of a wellbore and, in part, for example, within the wellbore. In addition, the process 500 can be implemented, in part, for example, in a laboratory, and, in part, for example, in the field. Moreover, the process 500 can be implemented, in part, by a laboratory technician, and, in part, by a field technician, for example, the wellbore operator.

At 502, an emulsifier is prepared from an alkyl ester of waste vegetable oil. For example, the emulsifier is prepared by implementing the example process 300 described earlier with reference to FIG. 3A. In some implementations, the waste vegetable oil can be vegetable oil which has been used for a process prior to preparing the emulsifier.

At 504, a quantity of the emulsifier is added to the oil-based drilling fluid to which the emulsifier has been added. A ratio of the quantity of the emulsifier to the quantity of the oil-based drilling fluid can range between 4 pounds (lbs) to 12 lbs of the emulsifier per barrel (pounds per barrel or “ppb”) of the oil-based drilling fluid. A barrel of the oil-based drilling fluid contains about 159 liters of the drilling fluid.

At 506, a quantity of lime is added to the oil-based drilling fluid to which the previously mentioned components have been added. A ratio of the quantity of the lime to the quantity of the oil-based drilling fluid can be substantially 6 lbs of lime per barrel of the oil-based drilling fluid. The lime activates the emulsifier, which then stabilizes the emulsion. The quantity of lime is related to the quantity of emulsifier. For example, the ratio of lime to emulsifier can range between 1:1 and 1:2.

At 508, a quantity of viscosifier is added to the oil-based drilling fluid to which the previously mentioned components have been added. A ratio of the quantity of the viscosifier to the quantity of the oil-based drilling fluid can be substantially 4 lbs of viscosifier per barrel of the oil-based drilling fluid. The viscosifier can be an organophilic clay. For example, the quantity of viscosifier can range from about 2 lbs to about 6 lbs.

At 510, a quantity of brine is added to the oil-based drilling fluid to which the previously mentioned components have been added. A ratio of the quantity of brine to the quantity of the oil-based drilling fluid can be substantially 85 lbs of brine per barrel of the oil-based drilling fluid. Calcium chloride in brine is used in OBM to capture water from shale formation and stabilize the shale section. In some implementations, the brine can include a quantity of calcium chloride (for example, substantially 61 lbs) mixed with water (for example, substantially 85 lbs).

At 512, a quantity of weigh-up material is added to the oil-based drilling fluid to which the previously mentioned components have been added. A ratio of the quantity of the weigh-up material to the quantity of the oil-based drilling fluid can be substantially 161 lbs of weigh-up material per barrel of the oil-based drilling fluid. The weigh-up material can be an inert material added to the drilling fluid to adjust the density of the OBM to the desired level. The quantity of the weigh-up material depends on the desired mud density. At this point the inverted oil-based mud composition comprising the sodium salt of the esterified fatty acids from waste vegetable oil is formed.

At 514, the inverted oil-based drilling fluid mixed with the previously mentioned components is used in a wellbore drilling operation to drill a wellbore in a subterranean zone. For example, multiple barrels of the oil-based drilling fluid are prepared, each barrel mixed with the previously-mentioned components. The multiple barrels are flowed through a subterranean zone while drilling a wellbore in the subterranean zone.

FIG. 5B is a flowchart of an example process 550 for using the emulsifier produced by the example process of FIG. 3B in forming an oil-based drilling fluid. The process 550 uses a calcium salt of alkyl esterified fatty acids from vegetable oil.

At 552, the emulsifier is prepared using calcium hydroxide (slaked lime) and an alkyl ester of fatty acids from a vegetable oil. In some embodiments, the vegetable oil is a waste vegetable oil, where the waste vegetable oil has been processed for esterification as previously described. For example, the emulsifier is prepared by implementing the example process 350 described earlier with reference to FIG. 3B.

At 554, a quantity of the emulsifier is added to the oil-based fluid to which the emulsifier has been added. A ratio of the quantity of the emulsifier to the quantity of the oil-based drilling fluid can range between 4 pounds (lbs) to 12 lbs of the emulsifier per barrel (ppb) of the oil-based drilling fluid. A barrel of the oil-based drilling fluid contains substantially 159 liters of the drilling fluid.

In an embodiment, the emulsifier includes the sodium salts of alkyl esterified fatty acids of vegetable oil, such as those produced using the method shown in FIG. 3A and described previously. In another embodiment, the emulsifier includes the calcium salts of alkyl esterified fatty acids of vegetable oil, such as those produced using the method shown in FIG. 3B and described previously. In some other embodiments, the emulsifier is a blend of the sodium salts and the calcium salts of alkyl-esterified fatty acids of vegetable oil. In some embodiments, the vegetable oil may be a raw or virgin vegetable oil. In some other embodiments, the vegetable oil used may be a waste vegetable oil. In some embodiments, the vegetable oil is a blend of raw or virgin and waste vegetable oils.

At 556, a quantity of emulsifier activator is introduced to the mixture of oil-based fluid to which the previously mentioned components have been added. In some embodiments, the emulsion activator is lime (that is, calcium carbonate). A ratio of the quantity of the lime to the quantity of the oil-based drilling fluid can be substantially 6 lbs of lime per barrel of the oil-based drilling fluid. The emulsifier activator activates the emulsifier, which then stabilizes the emulsion so as to form the invert emulsion. The quantity of lime is related to the quantity of emulsifier. For example, the weight ratio of emulsifier activator to emulsifier can be in a range of from about 1:1 to about 1:2. Other compounds that generate divalent ions, like other calcium and magnesium-based compounds, may be used as the emulsifier activator.

At 558, a quantity of viscosifier is introduced to the mixture of oil-based fluid to which the previously mentioned components have been added. The viscosifier is added after the emulsion is activated. A ratio of the quantity of the viscosifier to the quantity of the oil-based drilling fluid can be substantially 4 lbs of viscosifier per barrel of the oil-based drilling fluid. In some embodiments, the viscosifier can be an organophilic clay. For example, the quantity of viscosifier can range from about 2 lbs to about 6 lbs per barrel of oil-based drilling fluid. In some alternative embodiments, fatty acid dimers can be used as the viscosifier.

At 560, a quantity of water is introduced to the oil-based drilling to which the previously mentioned components have been added. In some embodiments, the water can be fresh water, synthetic or natural sea water, synthetic or natural brine, brackish water, formation water, production water, or other types of mineral or organic-laden aqueous compositions. In some embodiments, the water is a synthetic brine. A variety of salts may be selected from to compose the synthetic brine, including but not limited to, sodium salts, potassium salts, lithium salts, calcium salts, magnesium salts, and combinations of salts, including naturally-occurring salts of the sea, and combinations thereof. A ratio of the quantity of brine to the quantity of the oil-based drilling fluid can be substantially 85 lbs of brine per barrel of the oil-based drilling fluid. Calcium chloride in brine is used in OBMs to capture water from shale formations to stabilize the shale section (prevent clay swelling, which may destabilize the wellbore wall). In some implementations, the brine can include a quantity of calcium chloride (for example, substantially 61 lbs) mixed with water (for example, substantially 85 lbs). The quantity of the formed brine per barrel of the oil-based drilling fluid can be substantially 85 lbs of brine. In some embodiments, the ratio of the water-based fluid in the oil-based fluid for the invert OBM is in a range of from about 50:50 to about 10:90. In some other embodiments, the ratio of water-based fluid in the oil-based fluid is about 30:70. With this addition, embodiments of the invert oil-based mud composition comprising the calcium salts of the esterified fatty acids of vegetable oil is formed.

At 562, a quantity of weighing material is added to the mixture of oil-based drilling to which the previously mentioned components have been added. The quantity of the weighing material per barrel of the oil-based drilling fluid can be substantially 161 lbs of weighing material. A quantity of weighing material can be added to the drilling fluid such that the density of the OBM is in a range of from about 60 pounds per cubic foot to about 160 pounds per cubic foot.

### Method of Use of the OMB with Esterified Fatty Acid Emulsifier

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit.

In some embodiments, the system can include a drillstring disposed in a wellbore, the drillstring including a drill bit at a downhole end of the drillstring. The system can include an annulus between the drillstring and the wellbore. The system can also include a pump configured to circulate the composition through the drill string, through the drill bit, and back above-surface through the annulus. The system can include a fluid processing unit configured to process the composition exiting the annulus to generate a cleaned drilling fluid for recirculation through the wellbore.

An invert oil-based drilling fluid mixed with the previously-described components, including, for example, the sodium salts of the alkyl esterified fatty acids of the waste vegetable oil or the calcium salts of the alkyl esterified fatty acids of vegetable oils, or a combination thereof, is introduced into a wellbore for use in a drilling operation. Drilling operations may include the step of drilling a wellbore in a subterranean zone. For example, multiple barrels of the oil-based drilling fluid are prepared, each barrel mixed with the previously-described components. The multiple barrels are flowed through a subterranean zone while drilling a wellbore in the subterranean zone.

### Testing Methods

The rheology of the fluid was characterized in terms of its plastic viscosity (PV) and yield point (YP). The YP and PV are parameters from the Bingham Plastic rheology (BP) model. The YP is determined by extrapolating the BP model to a shear rate of zero; it represents the stress required to move the fluid. The YP is expressed in the units of pounds per 100 square feet (lbs/100 ft²). The YP indicates the cuttings carrying capacity of the invert mud through an annulus, or, in simple terms, the ability of an invert mud to clean the hole. An YP value greater than 15 lbs/100 ft² is considered good for drilling. In some embodiments, the yield point of the invert oil-based mud is in a range of from about 10 lbs/100 ft² to about 40 lbs/100 ft².

The PV represents the viscosity of a fluid when extrapolated to infinite shear rate, expressed in units of centipoise (cP). The PV indicates the type and concentration of the solids in the IEF, and a low PV is preferred. Both PV and YP are calculated using 300 revolutions per minute (rpm) and 600-rpm shear rate readings on a standard oilfield viscometer as given in Equations 1 and 2.

PV=(600 rpm reading)−(300 rpm reading) (Equation 1) and

YP=(300 rpm reading)−PV (Equation 2).

In some embodiments, the PV for an oil-based mud having a density of less than 100 pounds per cubic foot (lb/ft³) is less than about 30. In some other embodiments, the PV for an oil-based mud having a density of greater than 100 lb/ft³ and less than 125 lb/ft³ is in a range of from about 30 to about 40. In some embodiments, the PV for an oil-based mud having a density of greater than 125 lb/ft³ is greater than 40.

Fluid loss characteristics were determined on a 175 mL capacity HPHT filter press cell following API 13B-2 recommendations. HPHT fluid loss is representative of the volume of fluid that seeps out of the formulation when a sample is placed under HPHT conditions, which simulates those of being downhole. The HPHT fluid loss test is performed at 300° F. at 500 psi for 30 minutes. The HPHT mud cake thickness is a measurement of accumulated solid particles on the filter paper that allows a clear fluid to seep out of the formulation. This measurement simulates the accumulation of solid particle of the wall of the wellbore due to the HPHT conditions and the seepage of fluids out of the mud formulation and into the rock formations downhole. After measuring for fluid loss, the thickness of the remaining filter cake may be measured. Generally, regarding thickness of the filter cake, a thinner filter cake with the same fluid results is better. Up to about 10 mL of fluid loss is acceptable.

Observation of the filtrate from the HPHT fluid loss testing is a good means for determining the effectiveness of an emulsifier. A “good” determination of emulsion stability will come from the observation that there is no separation of the oil-based fluid from the water-based fluid in the filtrate over a period.

### Example Process to Produce the Emulsifier

The process 300 to produce the emulsifier was implemented as described here. Substantially 300 milliliters (mL) of methyl ester of waste vegetable oil was taken in a beaker having a magnetic stirring bar and placed on a hot plate stirrer. The methyl ester was stirred at substantially 500 rotations per minute (rpm). A caustic soda solution was prepared by dissolving substantially 15 grams (g) of sodium hydroxide in 50 mL of water. The caustic soda solution was added to the methyl ester over a period of substantially two minutes, which turned the reaction mixture into a suspension. The reaction mixture was stirred for substantially 6 hours at substantially 60° C., and then allowed to be static for substantially 16 hours, which resulted in the reaction mixture becoming thick and of semi-solid consistency. Substantially 50 mL of water was added to the mixture. Hydrochloric acid (substantially 31%) was added drop-by-drop to the reaction mixture until the pH of the reaction mixture was around 4-5, upon which an oil phase separated out from the reaction mixture. The reaction mixture was transferred to a separation flask. The aqueous phase, which was separated from the non-aqueous phase by an emulsion layer, was removed from the separation flask. Substantially 50 mL of water was added to the remaining non-aqueous phase in the separation flask for washing and removing of any inorganic salts that remained in the non-aqueous phase. The aqueous phase formed again was removed from the separation flask, and the step was repeated. The remaining non-aqueous phase along with the emulsion was left in static condition to allow de-foaming of the emulsion. Water released upon de-foaming was removed from time to time. Finally, the non-aqueous phase was collected as a colorless liquid. This non-aqueous phase contained the resultant emulsifier of sodium salts of esterified fatty acids from waste vegetable oil.

### Example Process to Produce the Invert Emulsion OBM

In one example, a total of 350 mL of invert emulsion OBM was produced using 218 mL of Safra oil as the base OBM. To the Safra oil, 12 mL of the emulsifier produced by implementing the process 300 described earlier was added. To this mixture, 4 mL of EZ-mul was added. EZ-Mul is a secondary emulsifier used as a wetting agent for solids. To this mixture, 6 g of an activating agent, 4 g of a viscosifier, 6 g of a filtration control agent, 85 mL of brine and 161 g of weigh-up material were added. The brine was a solution of 61 g of calcium chloride in 85 cubic centimeter (cc) of water. The mixture was hot rolled for 16 hours at 300 degrees Fahrenheit (° F.) and 500 pounds per square inch (psi). The resulting invert emulsion OBM had a plastic viscosity of 24.2 cP, a yield point of 11.2° F., American Petroleum Institute (API) spurt loss of zero mL, API fluid loss of 0 mL, HPHT spurt loss of 0 mL (at 300° F. and 500 psi) and HPHT fluid loss of 3.4 mL (at 300° F. and 500 psi).

In another example, samples of invert emulsion OBM were produced as described in the preceding paragraph, except that the concentration of the emulsifier was varied to be 6 mL, 4 mL and 0 mL. For such samples, the plastic viscosities were 35 cP, 34 cP and 30 cP, respectively. The yield points were 12 lb/100 ft², 17 lb/100 ft² and 30 lb/100 ft², respectively. The API spurt losses were 0 mL, 0 mL and 0.2 mL, respectively. The API fluid losses were 1 mL, 2 mL and 9.3 mL, respectively. The HPHT spurt losses were 2 mL, 6 mL and 8 mL, respectively (at 300° F. and 500 psi). The HPHT fluid losses were 7 mL, 18 mL and 68 mL, respectively (at 300° F. and 500 psi). In sum, for concentrations ranging between 4 mL and 12 mL of emulsifier per 218 mL of Safra oil, the invert emulsion OBMs showed very good rheological properties and applicability as oil-based drilling fluids.

### Second Example Process to Produce the Emulsifier

The embodiment process 350 is used to produce embodiment calcium salts of the methyl esterified fatty acids from waste vegetable oil as an emulsifier. In the example described here and throughout this disclosure, the term “substantially” represents a permissible deviation of 5% from a disclosed quantity. Substantially 40 milliliters (mL) of methyl ester of fatty acids derived from waste vegetable oil was introduced into a beaker having a magnetic stirring bar. The beaker was placed on a hot plate stirrer. The methyl ester was stirred at about 300 RPM while the esterified fatty acids were heated to about 60° C. After reaching the first temperature of 60° C., 2.5 grams of slake lime (Ca(OH)₂) was introduced into the beaker as a solid. The addition was paced and measured so as to avoid forming as much of a suspension as feasible. Until the end of the process, the mixture was stirred at 300 RPM. The temperature of the mixture was maintained at the first temperature (about 60° C.) for another 6 hours. After six hours of mixing at the first temperature, the temperature was raised to about 75° C. and maintained for an additional hour. After the last hour, the mixture was cooled and the stirring halted. Upon obtaining room temperature, a waxy solid with light brown liquid was obtained. The resultant included the calcium salts of the methyl ester fatty acid from the waste vegetable oil. The resultant is ready for use as an emulsifier.

### Second Example Process to Produce the Invert Emulsion OBM

To test the effects of the calcium salts of esterified fatty acids from waste vegetable oil, 12 pounds-per-barrel (ppb) of the primary emulsifiers were used to formulate an 80 pounds per cubic foot (pcf) invert-emulsion refined mineral oil-based OBM. For both formulations, the target oil/water ratio was about 70:30.

For an embodiment invert OBM, a total of 350 mL of invert emulsion OBM was produced using 218 mL of refined mineral oil as the oil-based fluid for the base fluid of the OBM. To the refined mineral oil, 12 mL of the calcium salt of esterified fatty acids from waste vegetable oils produced using the process described in “Second Example Process to Produce Emulsifier” was introduced and blended with the refined mineral oil to form a mixture. To this mixture, 4 mL of EZ-MUL® (Halliburton Energy Services) was added. EZ-MUL acts as a secondary emulsifier and was used as a wetting agent for solids. To this mixture, 6 g of an emulsifier activating agent (lime), 4 g of a viscosifier (GELTONE V®; Halliburton Energy Services), 6 g of a filtration control agent (DURATONE® HT; Halliburton Energy Services), water-based fluid in the form of 85 mL of a synthetic brine (containing 61 g of calcium chloride), and 161 g of weighing material (barite) were added. Upon mixing, an embodiment invert oil-based mud composition comprising calcium salts of esterified fatty acids from waste vegetable oil formed.

A comparative example of an invert mud composition was produced to compare post-hot rolling properties. All of the invert emulsion OBM ingredients, quantities and steps for making the comparative example invert OBM are the same as making the example invert emulsion OBM except that the emulsifier produced using the process described in “Second Example Process to Produce Emulsifier” was replaced with an equivalent amount of INVERMUL® (Halliburton Energy Services). Upon mixing, a comparative example invert oil-based mud composition formed.

The embodiment invert oil-based mud composition and the comparative example invert OBM composition were each hot rolled for 16 hours at 300 degrees Fahrenheit (° F.) and 500 pounds per square inch (psi) to simulate exposure to downhole conditions.

The embodiment invert emulsion OBM was then tested for plastic viscosity and yield point; however, both could not be determined as the resultant product was too thick to measure rheological properties. Both the API spurt loss test and the fluid lost test both resulted in 0 mL fluid loss. The high-temperature, high-pressure (HPHT) spurt loss test, conducted at 300° F. and 500 psi, resulted in 0 mL loss. The HTHP fluid loss test, conducted at the same conditions, resulted in 5 mL in fluid loss. In examining the HTHP fluid loss filtrate of the embodiment invert emulsion OBM, there was no oil-water phase separation in the sample material even after allowing it to remain static at room conditions for 25 hours. In comparing the invert emulsion OBM using the sodium salt emulsifier and the invert emulsion OBM using the calcium salt emulsifier, both had a similar performance.

The comparative example OBM was then tested for plastic viscosity, which resulted in a value of 22.9 cP (centipoise). The test for yield point resulted in a value of 9.2 lbs/100 ft² (pounds per 100 feet squared). Both the API spurt loss test and the fluid lost test both resulted in 0 mL fluid loss. The HPHT spurt loss test, conducted at 300° F. and 500 psi, resulted in 0.4 mL fluid loss. The HTHP fluid loss test, conducted at the same conditions, resulted in 5.6 mL fluid loss. Once again, both invert emulsion OBMs performed similarly and well. The comparative example did not separate and it was stable with time.

### Third Example Process to Produce the Invert Emulsion OBM

In yet another example, a second embodiment invert emulsion OBM was produced using 218 mL of refined mineral oil as the oil-based fluid for the base fluid of the OBM. To the refined mineral oil, 6 mL of the calcium salt of esterified fatty acids from waste vegetable oils produced using the process described in “Second Example Process to Produce Emulsifier” was introduced and blended with the refined mineral oil. To this mixture, 4 mL of EZ-MUL® (Halliburton Energy Services) was added. To this mixture, 6 g of an emulsifier activating agent (lime), 4 g of a viscosifier (GELTONE V®; Halliburton Energy Services), 6 g of a filtration control agent (DURATONE® HT; Halliburton Energy Services), water-based fluid in the form of 85 mL of a synthetic brine (containing 61 g of calcium chloride), and 161 g of weighing material were added. Upon mixing, an embodiment invert oil-based mud composition comprising calcium salts of esterified fatty acids from waste vegetable oil formed.

A second comparative example of an invert mud composition was produced to compare post-hot rolling properties. All of the invert emulsion OBM ingredients, quantities and steps for making the comparative example invert OBM are the same as making the example invert emulsion OBM except the emulsifier produced using the process described in “Second Example Process to Produce Emulsifier” was completely removed. Upon mixing, a second comparative example invert oil-based mud composition formed.

The second embodiment invert oil-based mud composition and the second comparative example invert OBM composition were each hot rolled for 16 hours at 300 degrees Fahrenheit (° F.) and 500 pounds per square inch (psi) to simulate exposure to downhole conditions.

The second embodiment invert emulsion OBM was then tested for plastic viscosity, which resulted in a value of 28 cP. The test for yield point resulted in a value of 32 lbs/100 ft². Both the API spurt loss test and the fluid lost test both resulted in 0 mL fluid loss. The HPHT spurt loss test, again conducted at 300° F. and 500 psi, resulted in 4 mL fluid loss. The HTHP fluid loss test, conducted at the same conditions, resulted in 10 mL fluid loss. This embodiment invert emulsion OBM has a similar result to the invert emulsion OBM using sodium salts of methyl ester fatty acids of vegetable oil. This embodiment intervened emulsion OBM has a lower performance than the 12 mL calcium salt embodiment intervened emulsion OBM; however, the results are still satisfactory for use. The composition was stable and did not separate in time.

The second comparative example OBM was then tested for plastic viscosity, which resulted in a value of 32 cP. The test for yield point resulted in a value of 32 lb/100 ft². The API spurt loss test resulted in 0 mL fluid loss; however, the API fluid loss test resulted in 1 mL fluid loss. The HPHT spurt loss test, again conducted at 300° F. and 500 psi, resulted in 6 mL fluid loss. The HTHP fluid loss test, conducted at the same conditions, resulted in 22 mL fluid loss. In examining the HTHP filtrate of the second comparative example OBM there was significant oil-water phase separation in the sample material only after three hours at room conditions.

### A Method Of Use Of The Invert Oil-Based Mud (OBM)

As previously described, the invert oil-based much (OBM) are formulated for use not only in HTHP environments but also where there are reactive shales and clays. Introducing the formulation as previously described into a wellbore will facilitate drilling operations through such sections. In some embodiments, the wellbore has as section that is a high-temperature/high-pressure (HTHP) area. In some embodiments, the wellbore has a section that contains reactive shales. given that the emulsifier is a calcium salt, the interaction between the brine and the emulsifier permits a significant amount—up to 50%—of the composition of the invert OBM to be a calcium-salt based brine. That leads to significant material conservation of the hydrocarbon-base fluid.

Unless defined otherwise, all technical and scientific terms used have the same meaning as commonly understood by one of ordinary skill in the art to which these systems, apparatuses, methods, processes and compositions belong.

As used, the term “drilling fluid” refers to fluids, slurries, or muds used in drilling operations downhole, such as during the formation of the wellbore.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

The term “substantially” as used refers to a majority of, or mostly, as in at least about 50%, 60%, 70%, 80%, 90%, 95%, 96%, 97%, 98%, 99%, 99.5%, 99.9%, 99.99%, or at least about 99.999% or more. Throughout this disclosure, the term “substantially” can represent, for example, a permissible deviation of up to ±5% in value from a disclosed quantity.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

Thus, particular implementations of the subject matter have been described. Other implementations are within the scope of the following claims.

What is claimed is:

1. A method of making an invert oil-based mud (OBM) comprising the steps of:
introducing an emulsifier comprising a calcium salt of an alkyl esterified fatty acids from a vegetable oil to an oil-based fluid to form an oil-based fluid mixture,
introducing an emulsion activating agent to the oil-based fluid mixture, and
introducing a water-based fluid to the oil-based fluid mixture such that the invert OBM forms.

2. The method of claim 1 where a quantity of the calcium salt of the alkyl esterified fatty acids from the vegetable oil introduced is in a range of from about 4 pounds per barrel (ppb) to about 12 ppb.

3. The method of claim 1 where the alkoxy group of the calcium salt of the alkyl esterified fatty acids from the vegetable oil is selected from the group consisting of methoxy, ethoxy, propoxy, butoxy, and combinations thereof.

4. The method of claim 1 where the oil-based fluid is selected from the group consisting of a refined mineral oil, diesel oil, and combinations thereof.

5. The method of claim 1 where the quantity of emulsion activating agent introduced is in a ratio of emulsion to emulsion activating agent in a range of from about 1:1 to about 1:2.

6. The method of claim 1 where the emulsion activating agent introduced is lime.

7. The method of claim 1 where the emulsion activating agent is introduced after the step of introducing the calcium salt of the alkyl esterified fatty acids from the vegetable oil.

8. The method of claim 1 where the water-based fluid introduced is a synthetic brine comprising calcium chloride.

9. The method of claim 1 where water-based fluid introduced is such that the invert OBM has a water-to-oil volume ratio in a range of from about 50:50 to about 10:90.

10. The method of claim 1 further comprising the step of introducing a weighting material to the invert OBM after the step of introducing the water-based fluid.

11. The method of claim 1 where invert oil-based mud (OBM) has a density in a range of from about 60 pounds per cubic foot (pcf) to about 160 pcf.

12. The method of claim 1 further comprising the step of introducing a wetting agent after the step of introducing the emulsion activating agent.

13. The method of claim 1 where the vegetable oil comprises a waste vegetable oil.

14. The method of claim 1 where the emulsifier further comprises sodium salts of esterified fatty acids from a waste vegetable oil.

15. The method of claim 1 where the calcium salt of an alkyl esterified fatty acids consists essentially of calcium salts of unsaturated fatty acids.

16. The method of claim 1 where the calcium salt of an alkyl esterified fatty acids consists essentially of calcium salts of saturated fatty acids.

17. A composition comprising an invert oil-based mud (OBM), comprising:
an oil-based fluid,
an emulsifier comprising a calcium salt of an alkyl esterified fatty acids from a vegetable oil,
an emulsion activating agent, and
a water-based fluid,
where the invert OBM has a water-to-oil volume ratio in a range of from about 50:50 to about 10:90.

18. A method of using an invert oil-based mud (OBM), the method including the step of:
introducing the invert OBM into a wellbore, where the invert OBM comprises:
an oil-based fluid;
an emulsifier comprising a calcium salt of an alkyl esterified fatty acids from a vegetable oil;
an emulsion activating agent; and
a water-based fluid;
where the ratio of water-based fluid to oil-based fluid is in a range of from about 50:50 to about 10:90.

19. The method of claim 18 where the wellbore has a section that is high-temperature/high-pressure (HTHP).

20. The method of claim 18 where in the wellbore has a section that contains reactive shales.
